(19) United States
(12) Patent Application Publication
(10) Pub. No.: US 2007/0231476 A1
(43) Pub. Date: Oct. 4, 2007

(54) Printing Method

(75) Inventors: Leon Vincent, Oelegem (BE); Patrick Hellemans, Viersel (BE)

Correspondence Address: HOUSTON ELISEEVA, 4 MILITIA DRIVE, SUITE 4, LEXINGTON, MA, 02421, US

(73) Assignee: AGFA-GEVAERT N.V., Mortsel (BE)

(21) Appl. No.: 11/668,338

(22) Filed: Jan. 29, 2007

Related U.S. Application Data
(60) Provisional application No. 60/744,144, filed on Apr. 3, 2006.

(30) Foreign Application Priority Data
Mar. 31, 2006 (EP) 06112085.3

(51) Int. Cl. B41M 5/00

(52) U.S. Cl. 427/145

(57) ABSTRACT

A printing method wherein a lay out composition for a print sheet is defined as a hierarchical set of cells, independent of characteristics of a printing device. A printing model is generated for at least one image to be printed and/or associated annotation data by means of this lay out composition and links to data files. The printing model is converted into a bit map representation taking into account the printing characteristics of the printing device.

### RELATED APPLICATIONS

This application claims priority to European Patent Application No. 06112085.3, filed on Mar. 31, 2006, and claims the benefit under 35 USC 119(e) of U.S. Provisional Application No. 60/744,144, filed on Apr. 3, 2006, both of which are incorporated herein by reference in their entirety.

### BACKGROUND OF THE INVENTION

In existing systems, the lay-out of a reproduction, typically comprising one or more diagnostic images with associated annotations, is based on the use of pre-defined templates. A template consists of a description of a composition in which the position and the dimensions of each image as well as the associated position of annotations are defined. Commonly, such templates are stored in the memory of an output device such as a hard copy printer.

In an alternative state of the art mode of operation, the lay-out is composed in a work station and the image with the associated lay-out is transferred, via the DICOM protocol, as a single image to the reproduction device.

### SUMMARY OF THE INVENTION

A major problem of storing the templates in the memory of the printer is that the system is very rigid because the number of lay-outs of a reproduction and the configuration of the lay-outs is limited to the number and configuration of the standard, pre-defined templates that are stored in the output device. Examples of such lay-outs are: one image combined with one text window, two images of equal dimensions on a single reproduction, etc.

A disadvantage of composing the layout on the work station is that the work station needs to be in possession of the characteristics of the reproducing device, e.g. the printer. This mode of operation demands a lot of storage capacity and entrusts the work station with part of the job of the reproduction device.

It is an object to provide a printing method that overcomes the above-mentioned problems of the prior art modes of operation.

The present invention relates to a printing method, more specifically to the specification of the layout of a sheet to be printed. The method of this invention differs from the prior art in that instead of using pre-defined templates, the composition of a print sheet is now described by a model, which is independent of the specific characteristics of the reproducing device.

This model is then converted into a bit map representation taking into account the specific characteristics of the reproducing device such as resolution, pixel characteristics, etc. This conversion of a high-level model into a graphical image, represented by a bit map, is also called ‘graphical rendering’.

In the context of the present invention the term “print sheet” refers to a graphically rendered single sheet of film or paper comprising at least one image and optional annotations. A print sheet is generated for output on a hard copy printer (film-based or paper-based).

A “sheet layout” is an abstract representation defining all presentation aspects of the print sheet. It comprises placeholders for the various individual elements that define the print sheet.

An “annotation” refers to textual or symbolic data relating to the images on the print sheet.

“DICOM printing” refers to generating a hard copy output of the print sheet on a DICOM compatible (networked) printer device.

“Sheet composing” refers to the process of creating and manipulating “sheets” by assigning actual entities to image and annotation placeholders and attributes.

In general, according to one aspect, the invention features a printing method that comprises a number of steps. A lay out composition is retrieved for a print sheet from memory. The lay out composition is defined as a hierarchical structure of cells, the position and dimensions of a cell being hierarchically defined relative to a parent cell, independent of characteristics of a printing device. A printing model is created or composed for at least one image and/or associated data to be printed by means of said lay out composition and links to data files comprising said image or data to be printed. The printing model is converted into a bit map representation to be applied to the reproducing device taking into account printing characteristics of the reproducing device.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a cell,

FIG. 2 is an UML class diagram,

FIG. 3 is an example of a reproduction,

FIG. 4 is a representation of the composition of the example of FIG. 3,

FIG. 5 illustrates the workflow according to the present invention.

### DETAILED DESCRIPTION OF THE PREFERRED EMBODIMENTS

The composition of a print sheet is described in a so-called sheet model. This model describes the content and the geometry of a reproduction in a way that is independent from the reproducing device.

In this way graphical representations of the same model can be optimally generated for reproducing devices with diverging technical characteristics.

The concepts on which the sheet models are based are described below. They are based on the theory of object oriented modeling and its design patterns.

A sheet composition is described as a hierarchical structure of different types of cells such as a simple cell, a composed cell etc.

A cell is a closed surface (a rectangular area) defined within the surface of one parent cell. The position and dimensions of the cell are defined relative to a parent cell.

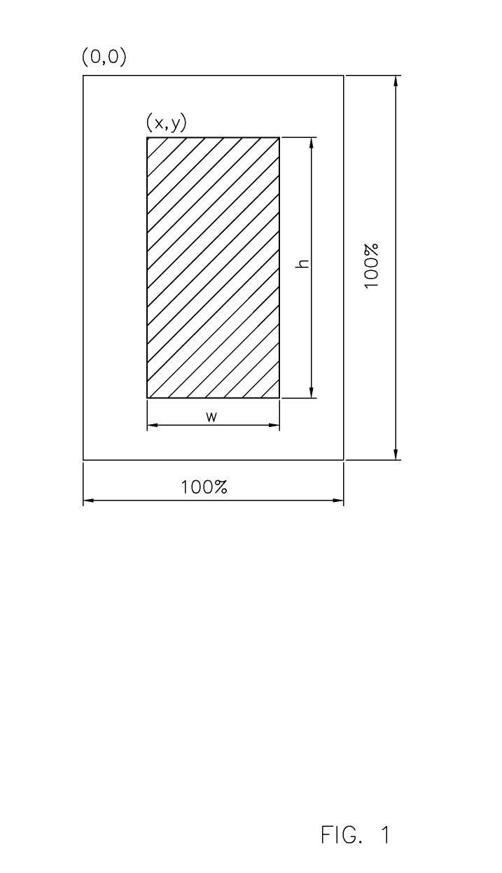

In the example of FIG. 1 a cell is shown with origin (x,y), width w and height h.

x, y, w and h are defined relative to the dimensions of the parent cell: x=y=0.25; w=h=0.50.

The content of a cell may be different depending on the type of the cell. This fact is modeled through the introduction of so-called sub-cells. Examples of sub-cells are described below.

In the particular application of medical imaging, image cells are cells the content of which is a representation of a diagnostic image. Attributes describe how the image can be optimally represented within the constraints of the cell (scales, image processing etc.).

Text cells are cells the content of which is text. Additional attributes are text, aligning of text within the cell, font-type, color etc.

Other types of cells may be required to represent the complex composition of a film in a realistic way. However, these types can always be designed according to the following principles.
A simple cell is a cell that has no children. In the medical imaging application, this cell type can used to represent diagnostic images that are to be reproduced as a whole.
Composite cells are cells that have zero or more children. These composite cells cluster a number of child cells within their surface. These child cells can in turn be composite cells so that a so-called composite pattern is obtained.

The purpose of the notion composite cell is to cluster other cells. A composite cell does not have a corresponding visual representation. It is a structure element which can be used in the composition of a sheet model to manipulate groups of cells as a single unit.

The above definition of a cell is given in a recursive way: a cell is defined with reference to its parent cell. This recursion ends in a parent-less cell. A model cell is characterized by the fact that is parentless and of composite type.

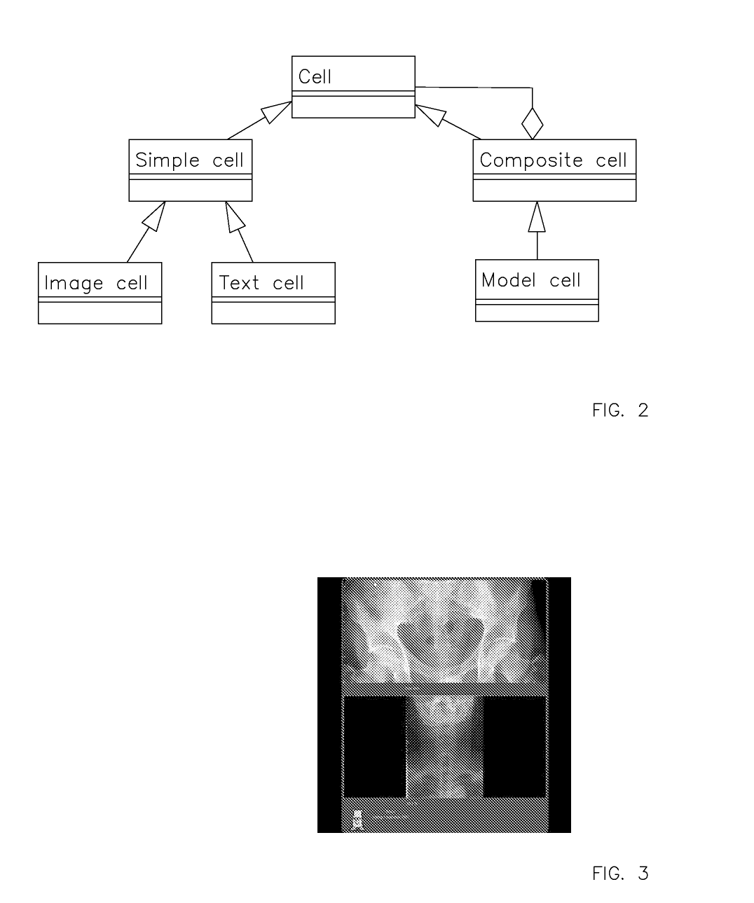

FIG. 2 illustrates the hierarchy of cell types by means of a unified modeling language (UML) class diagram.

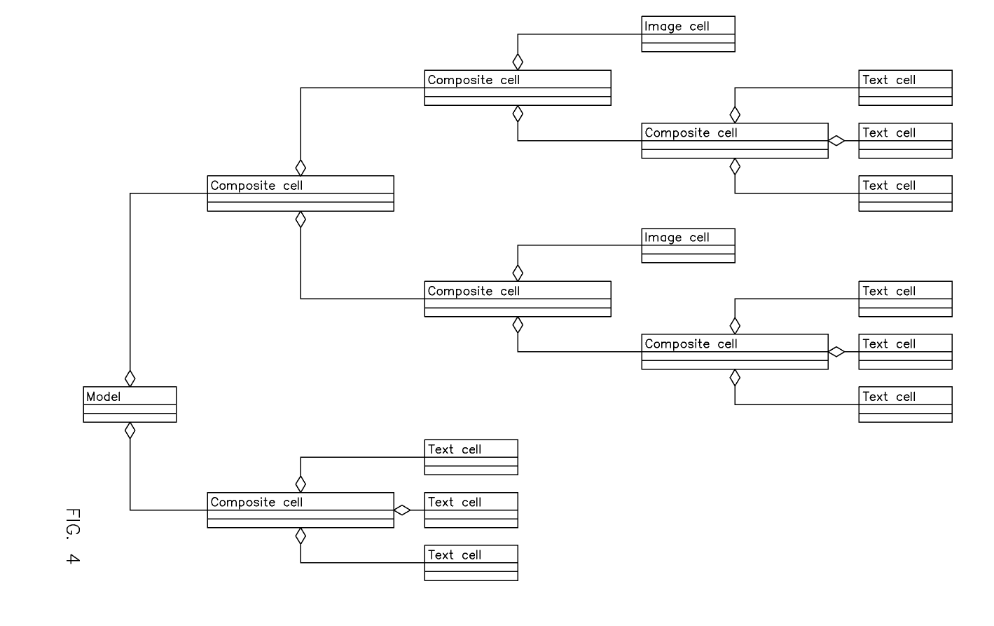

FIG. 3 is an example of a film composition for a medical reproduction from an x-ray imaging system.

The film composition of this example has two diagnostic images, each having a text box (a collection of related text cells).

At the bottom of the film a third text cell is provided.

The composition of this film can be represented by means of a structure of cells as shown in FIG. 4.

The root of this representation is an object of the model type. It comprises two child cells of composite type. The first of these composite cells comprises both images with their corresponding text boxes, the second one describes the text box which is provided at the bottom of the film. The three text boxes are composite cells having a number of text cells as children.

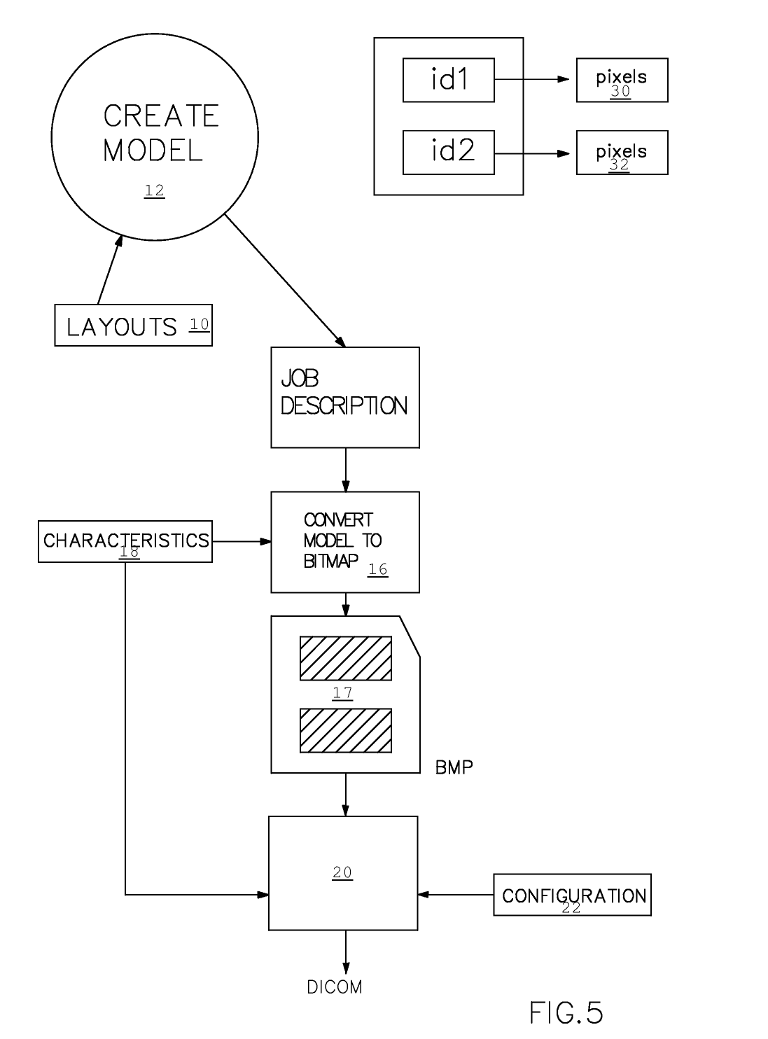

FIG. 5 illustrates the method according to the principles of the present invention.

A lay out composition 10 for a reproduction, e.g. a print sheet is retrieved from memory. The lay out composition is defined as a hierarchical set of components (cells, sub-cells, composite cells . . . ) as described earlier herein. The definition is hierarchical and independent of the characteristics of the reproducing device.

Next a printing model 12 is generated for at least one image (and annotation data). The printing model 12 is generated by means of the retrieved lay out composition and has links for each part of the lay out composition to data files id1, id2 comprising the image data and/or the annotation data 30, 32 to be printed in the cells of the retrieved lay out composition.

Next the printing model is converted into a bit map 16 representation to be applied to a printer taking into account the printing characteristics 18 of the printer 20. These characteristics are for example number of bits per pixel (8, 12, 16), dimensions of reproducing material, configuration details 22 (minimum and maximum reproducing density) etc.

The conversion is such that the relative definition of the cells is converted into an absolute definition of dimensions and the content of the cells adapted to the above described characteristics of the printing device 20.

Finally the bit map 17 is applied (e.g. taking into account DICOM printing requirements) to the printing device 20.

Having described in detail preferred embodiments of the current invention, it will now be apparent to those skilled in the art that numerous modifications can be made therein without departing from the scope of the invention as defined in the appending claims.

While this invention has been particularly shown and described with references to preferred embodiments thereof, it will be understood by those skilled in the art that various changes in form and details may be made therein without departing from the scope of the invention encompassed by the appended claims.

What is claimed is:

1. A printing method comprising the steps of:
retrieving a lay out composition for a print sheet from memory, the lay out composition being defined as a hierarchical structure of cells, the position and dimensions of the cells being hierarchically defined relative to a parent cell, independent of characteristics of a reproducing device;
creating a printing model for at least one image and/or associated data to be printed according to the lay out composition and links to data files comprising said image or data to be printed; and
converting the printing model into a bit map representation to be applied to the reproducing device taking into account printing characteristics of the reproducing device.

2. A printing method as claimed in claim 1, wherein the reproducing device is a paper printer.

3. A printing method as claimed in claim 1, wherein the reproducing device is a film reproducing device.

4. A printing method as claimed in claim 1, wherein the image and/or associated data are medical images and medical data.

5. A printing method as claimed in claim 1, wherein the image is an x-ray image.

6. A printing method as claimed in claim 1, wherein the image is a diagnostic image.

7. A printing method as claimed in claim 1, wherein the printing characteristics of the reproducing device comprise a number of bits per pixel.

8. A printing method as claimed in claim 1, wherein the printing characteristics of the reproducing device comprise dimensions of reproducing material.

9. A printing method as claimed in claim 1, wherein the printing characteristics of the reproducing device comprise a minimum and maximum reproducing density.

10. A printing method comprising the steps of:
retrieving a lay out composition for a print sheet from memory, the lay out composition being defined as a hierarchical structure of cells, the position and dimensions of the cells being hierarchically defined relative to a parent cell, independent of characteristics of a reproducing device;
creating a printing model for at least one diagnostic image and associated diagnostic data to be printed according to the lay out composition and links to data files comprising said diagnostic image and diagnostic data to be printed; and
converting the printing model into a bit map representation to be applied to the reproducing device taking into account printing characteristics of the reproducing device.
